(19) United States
(12) Patent Application Publication
(10) Pub. No.: US 2022/0264921 A1
(43) Pub. Date: Aug. 25, 2022

(54) NOVEL FLAVOR COMPOSITION AND METHODS OF PREPARATION AND USES THEREOF

(71) Applicant: INTERNATIONAL FLAVORS & FRAGRANCES INC., Union Beach, NJ (US)

(72) Inventors: Derek Greer, Jersey City, NJ (US); Charles Lee, Fords, NJ (US); Jurig-A Kim, Edgewater, NJ (US); Mare Van Der Ster, Tilurg (NL); Andrea Garcia, Langhorne, PA (US)

(73) Assignee: INTERNATIONAL FLAVORS & FRAGRANCES INC., Union Beach, NJ (US)

(21) Appl. No.: 17/626,163

(22) PCT Filed: Jul. 10, 2020
(86) PCT No.: PCT/US2020/041505

§ 371 Date: Jan. 11, 2022

Related U.S. Application Data
(60) Provisional application No. 62/872,768, filed on Jul. 11, 2019.

(51) Int. Cl. A23L 27/10; A23L 27/60; A21D 2/36

(52) U.S. Cl. CPC A23L 27/10; A23L 27/60; A21D 2/366; A23V 2002/00

(57) ABSTRACT

This invention provides a novel flavor composition containing a Jerusalem artichoke extract, and methods of preparation and uses thereof in improving, enhancing or modifying flavors in consumables.

### STATUS OF RELATED APPLICATION

This application is a 371 of international application serial number PCT/US2020/041505 filed Jul. 10, 2020 and claims priority to U.S. Provisional Patent Application No. 62/872,768, filed Jul. 11, 2019, the contents hereby incorporated by reference as if set forth in its entirety.

### FIELD OF THE INVENTION

The present invention relates to a novel flavor composition, and methods of preparation and uses thereof in improving, enhancing or modifying flavors in consumables.

### BACKGROUND OF THE INVENTION

Plant-based foods are thriving. Increasing numbers of consumers demand or prefer meat and dairy free or less products due to health, environment and animal welfare concerns. In responding to the evolving trends and requirements, flavor industry continuously explore and develop new taste, texture and mouthfeel solutions that are plant-based.

### SUMMARY OF THE INVENTION

This invention provides a novel flavor composition containing a Jerusalem artichoke extract, and methods of preparation and uses thereof in improving, enhancing or modifying flavors in consumables.

In one embodiment, the present invention is directed to a method of preparing a Jerusalem artichoke extract.

In another embodiment, the present invention is directed to a method of providing animalic, buttery, creamy, eggy and sulfurous taste to a consumable by adding an olfactory effective amount of the Jerusalem artichoke extract prepared according to the present invention to the consumable.

In another embodiment, the present invention is directed to a consumable containing an olfactory effective amount of the Jerusalem artichoke extract prepared according to the present invention.

These and other embodiments of the present invention will be apparent by reading the following specification.

### DETAILED DESCRIPTION OF THE INVENTION

Jerusalem artichoke (Helianthus tuberosus Linne) is a tuberous perennial plant of the Asteraceae family, which originates from North America. It is also called sunroot, sunchoke or earth apple.

The tubers are rich in inulin, a fructan polymer that can be broken into fructose and glucose, which can subsequently be converted into ethanol at high yields by fermentation. Jerusalem artichoke has, in recent years, become one of the most valuable energy plants for its potential application as high volume-low cost renewable transportation fuel (Bhagia, et al., Biofuel Research Journal (2017) 14: 587-599). Inulin is a natural storage polysaccharide with a large variety of food and pharmaceutical applications. Both inulin and its hydrolysate oligofructose have bifidus-enhancing effect, which promotes intestinal bifidobacteria. It is also one of the best water-soluble dietary fibers. Inulin is therefore advantageous to the growth of beneficial microorganisms, lowering intestinal pH, preventing obesity, regulating blood sugar levels, lowering blood fat, regulating intestinal flora, preventing constipation, diarrhea, preventing dental caries and promoting vitamin synthesis. Further, several bioactive compounds from the above ground parts of Jerusalem artichoke have been isolated which have shown antifungal, antioxidant and anticancer activities (CN106722561A; Szewczyk, et al., Annals of Agricultural and Environmental Medicine (2019) 26(1): 24-28). In addition to inulin, Jerusalem artichoke is also rich in oligofructose, dietary fiber, protein, mineral elements and other essential nutrients. The plant has wide adaptability and is resistant to barrenness. Therefore, Jerusalem artichoke has been cultivated for ages for food use due to both nutritional and health benefits. For example, it has been suggested for pickle preparations (CN106722561A; CN106262286A; CN106579288A; CN104738480B; CN107637804A; CN106722563A; CN105054023A; CN106579178A) as well as uses in beverages, snacks, preserved fruits, nutritive pastries, meat products and sauces (CN1371635A; CN104489567A; CN106306101A; CN105230926A; CN105981888A; CN105145718A; CN108850067A; CN108142861A; CN103989139B; CN105614834B).

Jerusalem artichoke has a slightly sweet flavor due in large part to the presence of inulin. However, it has only now been surprisingly found that a flavor composition containing a Jerusalem artichoke extract provides unexpected taste to a consumable.

Specifically, a method of preparing a Jerusalem artichoke extract is provided in the present invention, and an olfactory effective amount of the Jerusalem artichoke extract prepared according to the present invention provides unexpected animalic, buttery, creamy, eggy and sulfurous taste to a consumable such as a food product, a dental hygienic product or a medicinal product.

In the present invention, a Jerusalem artichoke concentrate is commercially available or prepared by methods known to a skilled person such as (i) contacting Jerusalem artichoke tuber with water, an organic solvent, or a combination thereof; and/or (ii) pressing Jerusalem artichoke tuber. A compound selected from the group consisting of an amino acid, an amino acid derivative, a vitamin, a vitamin derivative and a mixture thereof is then added to the concentrate to provide a first mixture. The first mixture is stirred and adjusted to a first pH value of about 7.7-8.0 to provide a second mixture. The second mixture is then heated to about 90-110° C., maintained at this temperature for at least about 30 minutes and subsequently cooled to an ambient temperature of about 20-40° C. to provide the Jerusalem artichoke extract. Depending on the requirement of subsequent applications, the resulting Jerusalem artichoke extract can be optionally adjusted to a second pH value of about 2.5-8.0. In addition, an optional drying step can be included to provide the Jerusalem artichoke extract in d, powder and/or flake form.

In some embodiments, the organic solvent is miscible with water. Examples of suitable organic solvents include, for example, but are not limited to, ethanol, acetone, methanol, n-propanol, and iso-propanol. In particular embodiments, the organic solvent is ethanol, e.g., 200 proof (absolute ethanol), 190 proof (95% ethanol) or 180 proof (90% ethanol). In yet other embodiments, a combination of water and one or more of the above-referenced organic solvents is used to prepare the Jerusalem artichoke concentrate. The ratio of water to organic solvent can vary and is desirably in the range of 10-90% water to 10-90% organic solvent. More preferably, the ratio of water to organic solvent is 70:30, 60:40, 50:50, 40:60 or 30:70. In some embodiments, the means of pressing Jerusalem artichoke tuber include, for example, but are not limited to, expeller pressing and cold pressing. In some embodiments, the Jerusalem artichoke concentrate obtained from steps (i) and (ii) contains about at least 5 Brix of solids, preferably about 5-100 Brix of solids.

In some embodiments, the compound is an amino acid or an amino acid derivative. Examples of suitable amino acids and amino acid derivatives include, for example, but are not limited to, cysteine, methionine, aspartic acid, glutamic acid, arginine, histidine, lysine, asparagine, glutamine, serine, threonine, phenylalanine, tryptophan, tyrosine, alanine, glycine, isoleucine, leucine, proline, valine and a derivative thereof. In particular embodiments, the amino acids and the amino acid derivatives include cysteine, methionine and a derivative thereof. In yet other embodiments, the compound is a vitamin or a vitamin derivative. In particular embodiments, the vitamins and the vitamin derivatives include thiamine and a derivative thereof.

In some embodiments, the Jerusalem artichoke concentrate and the compound in the first mixture have a weight ratio of at least about 0.01, preferably about 0.1-50, and more preferably about 0.5-10.

In some embodiments, the preparation requires a first pH value of 7.7-8.0, and preferably of 7.8-7.9. The pH value is adjusted using agents known in the art including, for example, but not limited to, sodium hydroxide, ammonium hydroxide and potassium hydroxide, or phosphoric acid and hydrogen chloride.

In some embodiments, the second mixture is heated at about 90-110° C. for at least about 30 minutes, preferably for about 1-3 hours, and more preferably for about 90-120 minutes.

In some embodiments, the optional drying step includes, for example, but is not limited to, drum drying (also known as roll drying), spray drying, tray drying and belt drying.

An example of the method for preparing a Jerusalem artichoke extract of the present invention comprises the steps of:
(i) providing a Jerusalem artichoke concentrate containing about at least 5 Brix of solids by means of pressing of Jerusalem artichoke tuber;
(ii) mixing the Jerusalem artichoke concentrate and L-cysteine at a weight ratio of about 1 to provide a first mixture;
(iii) adjusting a first pH value of the first mixture to 7.8 with sodium hydroxide (NaOH) to provide a second mixture;
(iv) heating the second mixture to 100° C., maintaining at 100° C. for 2 hours, and cooling to 40° C. to provide the Jerusalem artichoke extract; and
(v) adjusting a second pH value of the Jerusalem artichoke extract to 7.8 with sodium hydroxide followed by spray drying to afford a dry powder.

The present invention has made surprising and unexpected discovery of the requirement of the first pH value of 7.7-8.0 during the preparation. When the first pH value is less than 7.7, the obtained extract exhibits off taste including astringent, bitter, burnt protein-like, drying, sour, slightly umami and very weak. When the first pH value is greater than 8.0, the obtained extract exhibits rotten egg-like, livery and fecal characters. The present invention further requires heating at about 90-110° C. for at least about 30 minutes. It is understood by a skilled in the art that the higher the heating temperature, the shorter the heating time needed. In general, when the heating temperature is 80° C. or lower, the obtained extract exhibits weak or none eggy but more chicken-like notes. When the heating temperature is 135° C. or higher, the obtained extract exhibits burnt and charred taste.

The Jerusalem artichoke extract may also be further fractionated to a single compound or combination of compounds that have the desired activity of providing animalic, buttery, creamy, eggy and sulfurous taste to a consumable. Such fractionation can be carried out by well-known methods including, for example, but not limited to, precipitation, centrifugation, filtration, ultrafiltration, selective digestion, extraction, chromatography, electrophoresis or complex formation. Each resulting subfraction may be assayed for the desired activity using the original assay until a pure, active agent is obtained.

In some embodiments, the Jerusalem artichoke extract is added to a food product before, during or after the food production. In this respect, the Jerusalem artichoke extract can be a component of the food product (i.e., a food additive), or a spread, condiment, sauce, coating, glaze, or topping applied to the food product thereby improving the taste of the food product. In this respect, the extract can be provided as a liquid, semi-liquid, solid, semi-solid, powder, granule, etc. By improving the taste, it is meant that the Jerusalem artichoke extract has been demonstrated to provide animalic, buttery, creamy, eggy and sulfurous taste to a consumable.

The terms “Brix” and “degrees Brix” mean the same and refer to the percentage of soluble solids content.

The terms “an amino acid derivative” and “an amino acid salt” mean the same and refer to a salt, an ester or a complex of an amino acid with other physiologically acceptable substances. For example, cysteine derivatives may include, but are not limited to, a sodium salt, a potassium salt, a calcium salt, a magnesium salt, an ammonium salt, a hydrochloride salt, NAC (N-acetylcysteine), SCMC (S-carboxymetylcysteine), a tert-butoxycarbonyl (Boc) group protected cysteine monomer or derivative such as BOC-CYS(ME)-OH, (R)—S-(2-amino-2-carboxyethyl)-L-homocysteine, (R)-2-amino-3-sulfopropionic acid, D-2-amino-4-(ethylthio)butyric acid, 3-sulfino-L-alanine, Fmoc-cys(Boc-methyl)-OH, seleno-L-cystine, S-(2-thiazolyl)-L-cysteine, S-(2-thienyl)-L-cysteine, S-(4-tolyl)-L-cysteine, cystine, a zinc-cysteine complex, a manganese-cysteine complex, an iron-cysteine complex, a copper-cysteine complex, a magnesium-cysteine complex and a mixture thereof. A cysteine derivative of the present invention can be converted to cysteine or a sulfanyl group-containing compound. Methionine derivatives may include, for example, but are not limited to, a sodium salt, a potassium salt, a calcium salt, a magnesium salt, an ammonium salt, a hydrochloride salt, a zinc-methionine complex, a manganese-methionine complex, an iron-methionine complex, a copper-methionine complex, a magnesium-methionine complex, N-acetyl-methionine, (2S)-2-[[[4-[[(2R)-2-amino-3-mercaptopropyl]amino]-2-phenylphenyl]-oxomethyl]amino]-4-(methylthio)butanoic acid, 2-(1,3-benzothiazol-2-ylamino)-4-(methylthio)butanoic acid, 2-[(6-bromo-4-quinazolinyl)amino]-4-(methylthio)butanoic acid, 2-[[(4-ethylphenyl)-oxomethyl]amino]-4-(methylthio)butanoic acid methyl ester, 2-amino-4-(methylsulfanyl)-N-(2-naphthyl)butanamide, L-methionine methylsulfonium iodide, methionine sulfoxide, methionine sulfone, methionine sulfoximine, methioninehydroxamic acid and a mixture thereof.

The terms “a vitamin derivative” and “a vitamin salt” mean the same and refer to a synthetic or natural vitamin-derived and physiologically acceptable substance. For example, thiamine derivatives may include, but are not limited to, thiamine monophosphate (ThMP), thiamine diphosphate (ThDP), also sometimes called thiamine pyrophosphate (TPP), thiamine triphosphate (ThTP), adenosine thiamine diphosphate (AThDP), adenosine thiamine triphosphate (AThTP), thiamine mononitrate (TMN), thiamine hydrochloride (TCl), thiamine chloride hydrochloride (TClHCl), benfotiamine (S-benzoylthiamine O-monophosphate), thiamine tetrahydrofurfuryl disulfide (TTFD), sulbutiamine (isobutyryl thiamine disulfide), thiamine dilaurylsulfate (TLS) and a mixture thereof.

A consumable includes, for example, a food product (e.g., a beverage), a dental hygienic product and a medicinal product such as a pharmaceutical composition, a dietary supplement or a nutraceutical. The consumable may further contain a flavoring.

In some embodiments, a consumable is a food product including, for example, but not limited to, fruits, vegetables, juices, meat products such as ham, bacon and sausage, egg products, fruit concentrates, gelatins and gelatin-like products such as jams, jellies, preserves and the like, milk products such as ice cream, sour cream and sherbet, icings, syrups including molasses, corn, wheat, rye, soybean, oat, rice and barley products, nut meats and nut products, cakes, cookies, confectionaries such as candies, gums, fruit flavored drops, chocolates, chewing gums, mints, creams, pies and breads.

In some embodiments, the food product is a beverage including, for example, but not limited to, coffee, tea, carbonated soft drinks, such as COKE and PEPSI, non-carbonated soft drinks and other fruit drinks, sports drinks such as GATORADE and alcoholic beverages such as beers, wines and liquors. A consumable also includes prepared packaged products, such as granulated flavor mixes, which upon reconstitution with water provide non-carbonated drinks, instant pudding mixes, instant coffee and tea, coffee whiteners, malted milk mixes, pet foods, livestock feed, tobacco and materials for baking applications, such as powdered baking mixes for the preparation of breads, cookies, cakes, pancakes, donuts and the like. A consumable also includes diet or low-calorie food and beverages containing little or no sucrose. A preferred consumable includes a vegan mayonnaise, a vegan pasta, a vegan egg, a vegan custard, a vegan soup, a vegan sauce, a vegan baked goods, a vegan dairy product (e.g., a vegan yogurt, a vegan ice cream, and a vegan cheese), a vegan meat, a vegetarian mayonnaise, a vegetarian pasta, a vegetarian egg, a vegetarian custard, a vegetarian soup, a vegetarian sauce, a vegetarian baked goods, a vegetarian dairy product (e.g., a vegetarian yogurt, a vegetarian ice cream, and a vegetarian cheese), a vegetarian meat and alike. Consumables further include condiments such as herbs, spices and seasonings, flavor enhancers (e.g., monosodium glutamate), dietetic sweeteners and liquid sweeteners.

In some embodiments, a consumable is a dental hygienic product including, for example, but not limited to, a toothpaste, a mouthwash, a plaque rinse, a dental floss, a dental pain reliever (such as ANBESOL) and the like.

In some embodiments, a consumable is a medicinal product including a pharmaceutical composition, a dietary supplement and a nutraceutical. The medicinal product contains pharmaceutical and biological agents. Such active agents are well known in the art (See, e.g., The Physician's Desk Reference). Such compositions can be prepared according to procedures known in the art, for example, as described in Remington's Pharmaceutical Sciences, Mack Publishing Co., Easton, Pa. In one embodiment, such an active agent includes a bronchodilator, an anorexiant, an antihistamine, a nutritional supplement, a laxative, an analgesic, an anesthetic, an antacid, a H2-receptor antagonist, an anticholinergic, an antidiarrheal, a demulcent, an antitussive, an antinauseant, an antimicrobial, an antibacterial, an antifungal, an antiviral, an expectorant, an anti-inflammatory agent, an antipyretic and a mixture thereof. In another embodiment, the active agent is selected from the group consisting of an antipyretic and analgesic, e.g., ibuprofen, acetaminophen or aspirin, a laxative, e.g., phenolphthalein dioctyl sodium sulfosuccinate, an appetite depressant, e.g., an amphetamine, phenylpropanolamine, phenylpropanolamine hydrochloride, or caffeine, an antacid, e.g., calcium carbonate, an antiasthmatic, e.g., theophylline, an antidiarrheal, e.g., diphenoxylate hydrochloride, an agent against flatulence, e.g., simethecon, a migraine agent, e.g., ergotamine tartrate, a psychopharmacological agent, e.g., haloperidol, a spasmolytic or sedative, e.g., phenobarbital, an antihyperkinetic, e.g., methyldopa or methylphenidate, a tranquilizer, e.g., a benzodiazepine, hydroxyzine, meprobramate or phenothiazine, an antihistaminic, e.g., astemizol, chlorpheniramine maleate, pyridamine maleate, doxlamine succinate, brompheniramine maleate, phenyltoloxamine citrate, chlorcyclizine hydrochloride, pheniramine maleate, or phenindamine tartrate, a decongestant, e.g., phenylpropanolamine hydrochloride, phenylephrine hydrochloride, pseudoephedrine hydrochloride, pseudoephedrine sulfate, phenylpropanolamine bitartrate, or ephedrine, a beta-receptor blocker, e.g., propranolol, an agent for alcohol withdrawal, e.g., disulfuram, an antitussive, e.g., benzocaine, dextromethorphan, dextromethorphan hydrobromide, noscapine, carbetapentane citrate, chlophedianol hydrochloride, a fluorine supplement, e.g., sodium fluoride, a local antibiotic, e.g., tetracycline or clindamycin, a corticosteroid supplement, e.g., prednisone or prednisolone; an agent against gout, e.g., colchicine or allopurinol, an antiepileptic, e.g., phenytoin sodium, an agent against dehydration, e.g., electrolyte supplements, an antiseptic, e.g., cetylpyridinium chloride, a NSAID, e.g., acetaminophen, ibuprofen, naproxen, or a salt thereof, a gastrointestinal active agent, e.g., loperamide and famotidine, an alkaloid, e.g., codeine phosphate, codeine sulfate, or morphine, a supplement for trace elements, e.g., sodium chloride, zinc chloride, calcium carbonate, magnesium oxide, and other alkali metal salts and alkali earth metal salts; a vitamin, an ion-exchange resin, e.g., cholestyramine, a cholesterol-depressant and lipid-lowering substance, an antiarrhythmic, e.g., N-acetylprocainamide and an expectorant, e.g., guaifenesin. Examples of dietary supplements or nutraceuticals include, for example, but are not limited to, an enteral nutrition product for treatment of nutritional deficit, trauma, surgery, Crohn's disease, renal disease, hypertension, obesity and the like, to promote athletic performance, muscle enhancement or general well-being or inborn errors of metabolism such as phenylketonuria.

As used herein, the term “a” or “an” is understood to mean one or more. For example, a compound selected from the group consisting of an amino acid, an amino acid derivative, a vitamin, a vitamin derivative and a mixture thereof is understood to mean one compound or a mixture of different compounds referenced above.

The term “olfactory effective amount” is understood to mean an amount at which a flavor component, when used in a product including a food product, a dental hygienic product or a medicinal product, contributes its individual flavor characteristics in the product. However, the olfactory effect of the flavor formulation will be the sum of effect of each of the flavor ingredients. The olfactory effective amount may vary depending on many factors including other ingredients, their relative amounts and the olfactory effect that is desired. The amount of the Jerusalem artichoke extract of the present invention employed in a flavor formulation varies from about 10⁻⁵-20 weight percent, preferably about 10⁻⁴-5 weight percent and more preferably about 0.001-1 weight percent. Those with skill in the art will be able to employ the desired amount to provide desired flavor effect and intensity. Further, more olfactory effective amount desirable for various food products may be readily adjusted and determined by the skilled in the art in reference to the preparation and the olfactory effective amount established by the present invention.

Other modifications of this invention will be readily apparent to those skilled in the art. Such modifications are understood to be within the scope of this invention. As used herein all percentages are weight percent unless otherwise noted, ppm is understood to stand for parts per million, L is understood to be liter, mL is understood to be milliliter, g is understood to be gram, Kg is understood to be kilogram, mol is understood to be mole, mmol is understood to be millimole, psig is understood to be pound-force per square inch gauge and mmHg be millimeters (mm) of mercury (Hg). IFF as used in the examples is understood to mean International Flavors & Fragrances Inc., New York, N.Y., USA.

### Example I: Preparation of Jerusalem Artichoke Extract

A Jerusalem artichoke concentrate containing about 62 Brix of solids (commercially available from Ryan Trading Corporation, New York, U.S.) (2.444 g) was added to water (2.103 g) and mixed with a cysteine solution (40%, 4.280 g) to form a homogeneous mixture. A first pH value of the mixture was adjusted to 7.8 with sodium hydroxide (NaOH). The mixture was slowly heated to 100° C. over an hour and maintained at 100° C. for additional 100 minutes. The resulting Jerusalem artichoke extract (8.890 g) was then cooled to 40° C. and a second pH value of the extract was adjusted to 7.5 with phosphoric acid (H₃PO₄) for further evaluation.

### Example II: Preparation of Jerusalem Artichoke Extract Control Samples at Different pH

Jerusalem artichoke extract control samples 1-4 were similarly prepared according to Example I at respective different first pH values of 2.4, 6.9, 7.4 and 8.36.

### Example III: Preparation of Additional Jerusalem Artichoke Extract and Control Samples at Different Temperatures

Additional Jerusalem artichoke extracts and control samples 5-7 were similarly prepared according to Example I at respective different heating temperatures of 90, 110, 65, 80 and 135° C.

### Example IV: Evaluation of the pH Requirement for the Jerusalem Artichoke Extract Preparation

A base solution of sodium chloride (NaCl) was prepared in water at a concentration of 0.3%. Jerusalem artichoke extract (prepared above in Example I) and control samples 1-4 (prepared above in Example II) were each added to the base solution at a concentration of 0.2%. Sensory evaluation was conducted by a sensory panel. The base solution was the control. The results are as follows:

| | First | |
|---|---|---|
| Sample | pH Value | Changes of Flavor Profile |
| Jerusalem | 7.8 | Very strong animalic, umami, buttery, |
| artichoke | | creamy, egg yolk-like, egg-white like, |
| extract | | eggy and sulfurous |
| Control | 2.4 | Chicken flavor, astringent, bitter, |
| sample 1 | | burnt protein-like, drying and sour |
| | | with vegetal finish |
| Control | 6.9 | Umami, bitter and creamy, weak |
| sample 2 | | |
| Control | 7.4 | Astringent, bitter, burnt protein- |
| sample 3 | | like, drying, sour, slightly umami |
| | | and very weak |
| Control | 8.36 | Umami, strong sulfurous, slight rotten |
| sample 4 | | egg-like and livery characters developed |

Jerusalem artichoke extract prepared at a first pH value of 7.8 exhibited very strong animalic, umami, buttery, creamy, egg yolk-like, egg-white like, eggy and sulfurous notes with no undesirable off-taste. Such superior flavor properties were absent in the control samples prepared at respective first pH values of 2.4, 6.9, 7.4 and 8.36.

### Example V: Evaluation of the Temperature Requirement for Jerusalem Artichoke Extract Preparation

Jerusalem artichoke extract (prepared above in Example I), additional Jerusalem artichoke extracts and control samples 5-7 (prepared above in Example III) were each added to the sodium chloride base solution (prepared above in Example IV) at a concentration of 0.2%. Sensory evaluation was conducted by a sensory panel. The base solution was the control. The results are as follows:

| | Temperature | |
|---|---|---|
| Sample | (° C.) | Changes of Flavor Profile |
| Jerusalem | 100 | Very strong animalic, umami, buttery, |
| artichoke | | creamy, egg yolk-like, egg-white like, |
| extract | | eggy and sulfurous |
| Additional | 90 | Strong animalic, umami, buttery, creamy, |
| Jerusalem | | egg yolk-like, egg-white like, eggy and |
| artichoke | | sulfurous |
| extract | | |
| Additional | 110 | Slightly burnt, cooked and roasted, |
| Jerusalem | | onion-like, slightly astringent, fried |
| artichoke | | egg-like |
| extract | | |
| Control | 65 | Weak, watery, not eggy. |
| sample 5 | | |
| Control | 80 | Chicken-like, egg white-like, weak egg yolk- |
| sample 6 | | like |
| Control | 135 | Super burnt, charred, plastic-like and burned, |
| sample 7 | | roasted, onion-like |

Jerusalem artichoke extract prepared at 90, 100 and 110° C. exhibited animalic, umami, buttery, creamy, egg yolk-like, egg-white like, eggy and sulfurous notes. Such superior flavor properties, especially the eggy note, were absent in the control samples prepared at temperatures of 65, 80 and 135° C.

### Example VI: Application in Mayonnaise

A full mustard mayonnaise prepared based on Applicants' proprietary formulation had good texture, was not fishy or overly acidic. A corresponding egg-less and mustard-less control was prepared with 20% reduction in both egg and mustard content. The control was less eggy and had less mustard flavor. Mustard mayonnaises and corresponding controls prepared by other methods known to a skilled artisan can also be used for this application evaluation. Jerusalem artichoke extract (prepared above in Example I) was added to the control to yield various concentrations. Sensory evaluation was conducted by a sensory panel. The results are as follows:

| Jerusalem | |
|---|---|
| Artichoke Extract | |
| (%) | Changes of Flavor Profile |
| 0.005 | Slightly more eggy with slightly more mustard |
| | flavor when compared with the control |
| 0.015 | More eggy with more mustard flavor when |
| | compared with the control |
| 0.025 | Eggy with mustard flavor, close to the full |
| | mustard mayonnaise |

### Example VI: Application in Vegan Mayonnaise

Jerusalem artichoke extract (prepared above in Example I) was added to Hellmann's® Vegan to yield various concentrations. Sensory evaluation was conducted by a sensory panel. Hellmann's® Vegan was the control. The results are as follows:

| Jerusalem | |
|---|---|
| Artichoke Extract | |
| (%) | Changes of Flavor Profile |
| 0.07 | Upfront sulfurous note, eggy, full |
| 0.15 | Strong upfront sulfurous note, eggy, a metallic |
| | note started to develop |

### Example VII: Application in Vegan Egg

Jerusalem artichoke extract (prepared above in Example I) was added to JUST Egg to yield various concentrations. Sensory evaluation was conducted by a sensory panel. JUST Egg was the control. The results are as follows:

| Jerusalem | |
|---|---|
| Artichoke Extract | |
| (%) | Changes of Flavor Profile |
| 0.2 | More sulfurous and eggy |
| 0.4 | Even more sulfurous and eggy, a desirable |
| | aroma developed, vegetal off-flavors |
| | decreased |

### Example VIII: Application in Chicken Broth

A chicken broth base was prepared based on Applicants' proprietary formulation. Other chicken broth bases prepared by a method known to a skilled artisan can also be used for this application evaluation. Jerusalem artichoke extract (prepared above in Example I) was added to the chicken broth base to yield various concentrations. Sensory evaluation was conducted by a sensory panel. The chicken broth base was the control. The results are as follows:

| Jerusalem | |
|---|---|
| Artichoke Extract | |
| (%) | Changes of Flavor Profile |
| 0.01 | Very slight improvement |
| 0.03 | Eggy, cooked egg powder-like, succulent, |
| | full and fatty with more mouthfeel |
| 0.07 | Eggy, sulfurous, succulent, very full |
| 0.08 | Stronger and more complex flavors, not |
| | distorted |
| 0.10 | Flavors were boosted even more with a |
| | bitter finish |
| 0.20 | Very strong flavors, artificial and rubbery |
| | notes started to develop |

### Example IX: Application in Custard/Baked Goods

A flan custard prototype was prepared based on Applicants' proprietary formulation. Other flan custard prototypes prepared by a method known to a skilled artisan can also be used for this application evaluation. Jerusalem artichoke extract (prepared above in Example I) was added to the flan custard prototype to yield various concentrations. Sensory evaluation was conducted by a sensory panel. The flan custard prototype was the control. The results are as follows:

| Jerusalem | |
|---|---|
| Artichoke Extract | |
| (%) | Changes of Flavor Profile |
| 0.01 | Very slight improvement |
| 0.03 | Flavors were improved |
| 0.05 | Flavors were improved, more complex with |
| | more body and more background |
| 0.08 | Significant flavor improvement, eggy with a |
| | perception of authentic, simple and unique |
| 0.10 | Eggy and sulfurous, alliaceous note started |
| | to develop |

### Example X: Application in Cheese Seasoning

Jerusalem artichoke extract (prepared above in Example I) was added to cheddar cheese powder (Hoosier Hill Farm LLC, Fort Wayne Ind.) to provide a concentration of 0.2%. Sensory evaluation was conducted by a sensory panel. Jerusalem artichoke extract was identified to improve the salty and savory perception as well as the mouthfeel attributed by an eggy profile.

What is claimed is:

1. A method of preparing a Jerusalem artichoke extract comprising the steps of:
providing a Jerusalem artichoke concentrate by means of pressing of Jerusalem artichoke tuber;
(ii) adding a compound selected from the group consisting of an amino acid, an amino acid derivative, a vitamin, a vitamin derivative and a mixture thereof to the Jerusalem artichoke concentrate to provide a first mixture;
(iii) adjusting a first pH value of the first mixture to 7.7-8.0 to provide a second mixture; and
(iv) heating the second mixture to a temperature of about 90-110° C., maintaining at the temperature for at least about 30 minutes and cooling to an ambient temperature of about 20-40° C. to provide the Jerusalem artichoke extract.

2. The method of claim 1, wherein the Jerusalem artichoke concentrate contains at least about 5 Brix of solids.

3. The method of claim 1, wherein the compound is selected from the group consisting of cysteine, a cysteine derivative, methionine, a methionine derivative, thiamine, a thiamine derivative and a mixture thereof.

4. The method of claim 1, wherein the Jerusalem artichoke concentrate and the compound have a weight ratio of at least about 0.01.

5. The method of claim 1, wherein the Jerusalem artichoke concentrate and the compound have a weight ratio of about 0.1-50.

6. The method of claim 1, wherein the Jerusalem artichoke concentrate and the compound have a weight ratio of about 0.5-10.

7. The method of claim 1, wherein the first pH value is 7.8-7.9.

8. A flavor composition comprising an olfactory effective amount of a Jerusalem artichoke extract, wherein the Jerusalem artichoke extract is prepared by a method comprising the steps of:
(v) providing a Jerusalem artichoke concentrate by means of pressing of Jerusalem artichoke tuber;
(vi) adding a compound selected from the group consisting of an amino acid, an amino acid derivative, a vitamin, a vitamin derivative and a mixture thereof to the Jerusalem artichoke concentrate to provide a first mixture;
(vii) adjusting a first pH value of the first mixture to 7.7-8.0 to provide a second mixture; and
(viii) heating the second mixture to a temperature of about 90-110° C., maintaining at the temperature for at least about 30 minutes and cooling to an ambient temperature of about 20-40° C. to provide the Jerusalem artichoke extract.

9. The flavor composition of claim 8, wherein the Jerusalem artichoke concentrate contains at least about 5 Brix of solids.

10. The flavor composition of claim 8, wherein the compound is selected from the group consisting of cysteine, a cysteine derivative, methionine, a methionine derivative, thiamine, a thiamine derivative and a mixture thereof.

11. The flavor composition of claim 8, wherein the Jerusalem artichoke concentrate and the compound have a weight ratio of at least about 0.01.

12. The flavor composition of claim 8, wherein the olfactory effective amount is about 10⁻⁵-20 weight percent of the flavor composition.

13. The flavor composition of claim 8, wherein the olfactory effective amount is about 10⁻⁴-5 weight percent of the flavor composition.

14. The flavor composition of claim 8, wherein the olfactory effective amount is about 0.001-1 weight percent of the flavor composition.

15. A consumable containing a flavor composition, wherein the flavor composition comprising an olfactory effective amount of a Jerusalem artichoke extract prepared by a method comprising the steps of:
(i) providing a Jerusalem artichoke concentrate by means of pressing of Jerusalem artichoke tuber;
(ii) adding a compound selected from the group consisting of an amino acid, an amino acid derivative, a vitamin, a vitamin derivative and a mixture thereof to the Jerusalem artichoke concentrate to provide a first mixture;
(iii) adjusting a first pH value of the first mixture to 7.7-8.0 to provide a second mixture; and
(iv) heating the second mixture to a temperature of about 90-110° C., maintaining at the temperature for at least about 30 minutes and cooling to an ambient temperature of about 20-40° C. to provide the Jerusalem artichoke extract,
wherein the Jerusalem artichoke concentrate contains at least about 5 Brix of solids.

16. The consumable of claim 15, wherein the compound is selected from the group consisting of cysteine, a cysteine derivative, methionine, a methionine derivative, thiamine, a thiamine derivative and a mixture thereof.

17. The consumable of claim 15, wherein the Jerusalem artichoke concentrate and the compound have a weight ratio of at least about 0.01.

18. The consumable of claim 15, wherein the olfactory effective amount is about 10⁻⁵-20 weight percent of the flavor composition.

19. The consumable of claim 15, wherein the consumable is a food product.

20. The consumable of claim 19, wherein the food product is selected from the group consisting of a vegan mayonnaise, a vegan pasta, a vegan egg, a vegan custard, a vegan soup, a vegan sauce, a vegan baked goods, a vegan dairy product, a vegan meat, a vegetarian mayonnaise, a vegetarian pasta, a vegetarian egg, a vegetarian custard, a vegetarian soup, a vegetarian sauce, a vegetarian baked goods, a vegetarian dairy product and a vegetarian meat.
